(19) United States
(12) Patent Application Publication
(10) Pub. No.: US 2018/0198781 A1
(43) Pub. Date: Jul. 12, 2018

(54) DIGITAL FRAME AUTHENTICATION THROUGH CROWDSOURCING

(71) Applicant: International Business Machines Corporation, Armonk, NY (US)

(72) Inventors: Kulvir S. BHOGAL, Fort Worth, TX (US); Gregory J. BOSS, Saginaw, MI (US); Rick A. HAMILTON, II, Charlottesville, VA (US); William A. LEMKE, San Diego, CA (US)

(21) Appl. No.: 15/400,124

(22) Filed: Jan. 6, 2017

(51) Int. Cl. H04L 29/06; H04L 9/00; G06N 7/00; H04N 7/18; G06F 17/30

(52) U.S. Cl. CPC H04L 63/0853; H04L 9/006; G06F 17/30241; H04N 7/185; G06N 7/005

(57) ABSTRACT

A method, computer program product, and system for authenticating one or more frames includes a processor obtaining the frame(s) from a first client with data indicating a location at which the frame(s) was captured, and data indicating a time at which the frame(s) was captured. The processor identifies a clients of third parties within a pre-defined proximity of the location and at a time within a pre-defined proximity to the time at which the frame(s) was captured. The processor determines probabilities of whether the third parties have personal relationships with each other and with a user of the first client. The program code selects clients that have a high statistical probability of not having these personal relationships. The selected clients receive the frame(s) and append the frame(s) with client time and location metadata. The processor received the frame(s) and authenticates the frame(s) based on correlating the data and time data.

### BACKGROUND

Most people carry personal computing devices that include cameras capable of capturing both still and video digital images. Because of the prevalence of cameras, many newsworthy events are captured by bystanders and uploaded to websites for sharing. Thus, cameras on personal computing devices have been used to record important events as they are happening, when the media have not yet arrived on the scene to record. For this reason, amateur image and video content is increasingly relied upon for information. Thus, verifying that the videos and images that are uploaded and presented as authentic are indeed what they purport to be is important.

### SUMMARY

Shortcomings of the prior art are overcome and additional advantages are provided through the provision of a method for authenticating one or more frames. The method includes, for instance: obtaining, by one or more processors, one or more frames captured by an image capture program of a first client, data indicating a location at which the one or more frames were captured, and data indicating a time at which the one or more frames were captured; identifying, by the one or more processors, a plurality of clients of third parties within a pre-defined proximity of the location and at a time within a pre-defined proximity to the time at which the one or more frames were captured; determining, by the one or more processors, based on executing algorithms on personally identifiable information on the plurality of clients, probabilities of whether the third parties have personal relationships with each other and probabilities of whether each third party of the third parties has a personal relationship with a user of the first client; selecting, by the one or more processors, one or more clients from the plurality of clients, wherein a portion of the third parties associated with the one or more clients have a high statistical probability of not having the personal relationships with each other and have a high statistical probability of not having the personal relationship with the user, wherein the selected one or more clients receive the one or more frames and each client of the one or more clients appends the one or more frames with client time and client location metadata; receiving, by the one or more processors, from each of the one or more clients, the one or more frames appended with the metadata of the client; and authenticating, by the one or more processors, the one or more frames, based on correlating the data indicating the location at which the one or more frames were captured and the data indicating a time at which the one or more frames were captured with the metadata of the one or more clients.

Methods and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts a workflow illustrating certain aspects of an embodiment of the present invention;

FIG. 2 a workflow illustrating certain aspects of an embodiment of the present invention;

FIG. 3 depicts one embodiment of a computing node that can be utilized in a cloud computing environment;

FIG. 4 depicts a cloud computing environment according to an embodiment of the present invention; and

FIG. 5 depicts abstraction model layers according to an embodiment of the present invention.

### DETAILED DESCRIPTION

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention. As understood by one of skill in the art, the accompanying figures are provided for ease of understanding and illustrate aspects of certain embodiments of the present invention. The invention is not limited to the embodiments depicted in the figures.

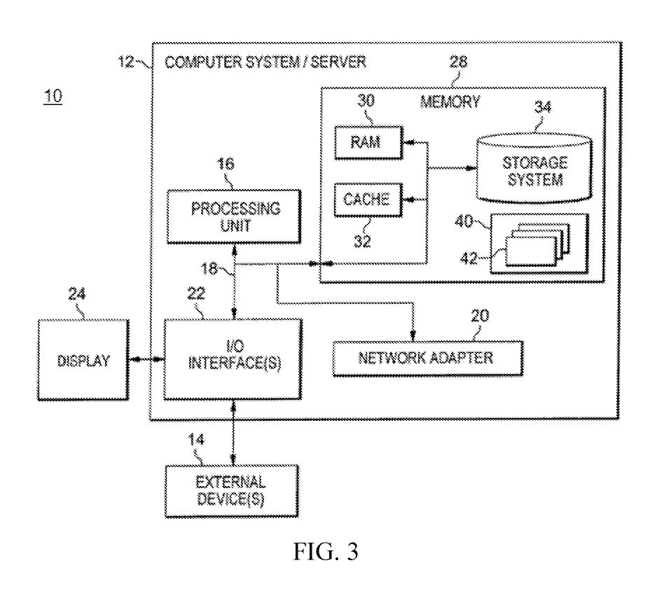

As understood by one of skill in the art, program code, as referred to throughout this application, includes both software and hardware. For example, program code in certain embodiments of the present invention includes fixed function hardware, while other embodiments utilized a software-based implementation of the functionality described. Certain embodiments combine both types of program code. One example of program code, also referred to as one or more programs, is depicted in FIG. 3 as program/utility 40, having a set (at least one) of program modules 42, may be stored in memory 28.

Embodiments of the present invention include a computer system, computer-implemented method, and computer program product for authenticating digital images and videos in relation to the location at which the image or video was taken, the time the image or video was taken, and the date the video or image was taken. An advantage of embodiments of the present invention is that they provide an authentication that carries a high level of trust. In addition to utilizing metadata embedded in images and videos captured, embodiments of the present invention also utilize another resource that can attest to the veracity of an image or video: peer review. Embodiments of the present invention utilize information from one or more individuals who were present when the image or video was captured to authenticate the image, i.e., peer to peer authentication. Thus, in embodiments of the present invention, program code executing on at least one processing circuit, utilizes location and date information from more than one computing device, in order to provide a cryptographic verification of an image and/or video that has been posted on a website, accessible via an Internet connection.

Embodiments of the present invention provide advantages over existing verification systems by leveraging information from individuals and computing devices (outside of the device that captured the media to be verified) present when a video or image was captured. By adding crowdsourcing in order to attain peer to peer authentication, embodiments of the present invention provide an improved level of verification for videos and images, including those that are posted online. Aspects of embodiments of the present invention represent improvements to computing technology because they provide an improved solution for identifying authentic and inauthentic content in digital media. The benefits to authentication provided are inextricably tied to computing at least because embodiments of the present invention utilize both communication networks and markers attainable and observable exclusively by computer systems, in order to verify the authenticity of digital media. The peer-to-peer authentication aspects of embodiments of the present invention are an improvement to existing authentication because utilizing peer to peer review renders the authentication less susceptible to fraud than authentication methods. For example, when existing authentication procedures rely exclusively on analyzing metadata associated with an image, the process is susceptible to fraud because a determined fraudster could digitally manipulate this data before uploading the image or video to a server, thereby “fooling” the server into marking the image or video as verified. Embodiments of the present invention employ one to multiple peers who are unknown to each other, thus, if a user manipulates an image before uploading it, the image will not be verified, as it would fail the peer review. Thus, because embodiments of the present invention utilize a crowdsourced set of data, in order for the authentication to be fraudulent, multiple people with personal computing devices, such as smartphones, would all have to collaborate to fabricate the data points from the different sources that permit the program code to authenticate the image or video. This scenario is unlikely, especially given that these individuals would have no contact with each other.

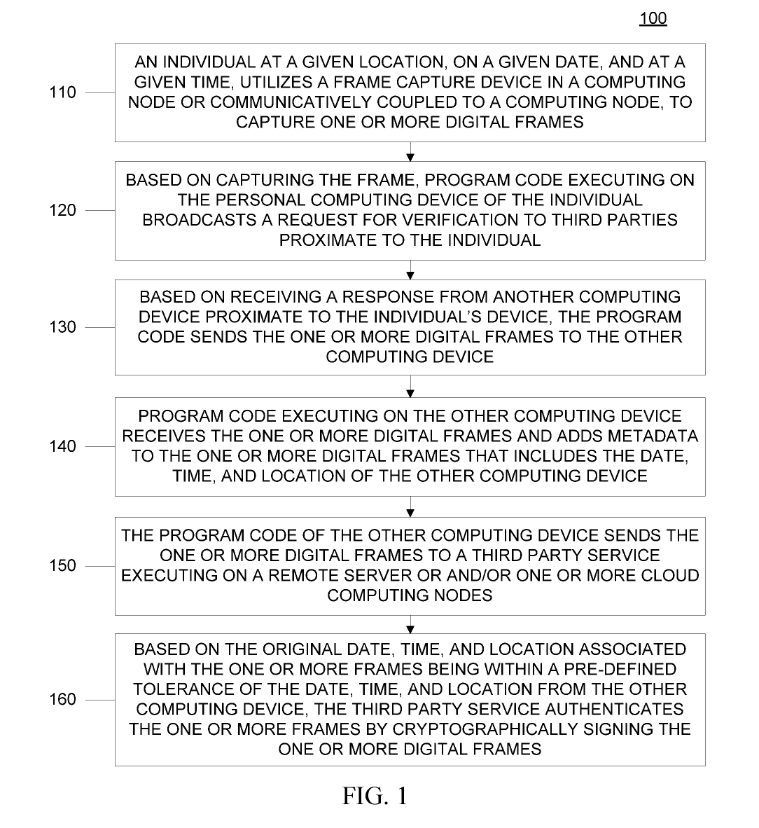

In an embodiment of the present invention, program code executing on at least one processing circuit authenticates one or more digital frames, which include images, which are each a single frame, as well as videos, which are comprised of a series of frames. The program code authenticates the digital frames relative to location, time, and date, by utilizing crowdsourcing techniques to identify parties that can attest to the authenticity of the frames. FIG. 1 is a workflow 100 of an embodiment of the present invention and provides an example of how embodiments of the present invention utilize crowdsourcing to attain peer to peer authentication in order to authenticate one or more digital frames.

Turning the FIG. 1, an individual at a given location, on a given date, and at a given time, utilizes a frame capture device in a computing node (e.g., FIG. 3, 10) or communicatively coupled to a computing node, to capture one or more digital frames (110). The computing node may be a personal mobile computing device. Based on capturing the frame, program code executing on the personal computing device of the individual broadcasts a request for verification to third parties proximate to the individual (120). The program code may publicly broadcast this request. Based on receiving a response from another computing device proximate to the individual's device, the program code sends the one or more digital frames to the other computing device (130). In another embodiment of the present invention, the program code's request may include the one or more digital frames. Program code executing on the other computing device receives the one or more digital frames and adds metadata to the one or more digital frames that includes the date, time, and location of the other computing device (140). The program code of the other computing device sends the one or more digital frames to a third party service executing on a remote server or and/or one or more cloud computing nodes (e.g., FIG. 3, 10) (150). Based on the original date, time, and location associated with the one or more frames being within a pre-defined tolerance of the date, time, and location from the other computing device, the third party service authenticates the one or more frames by cryptographically signing the one or more digital frames (160), providing verification. In an embodiment of the present invention, the program code of the other computing device encrypts the one or more frames with a public key before sending the one or more frames to the third party service, utilizing a public PKI (public key infrastructure) system. For both the initial computing device and the peer computing device, the location may be the publicly known GPS (global positioning system) location of the mobile devices and the date may be an SSID (short for service set identifier) date.

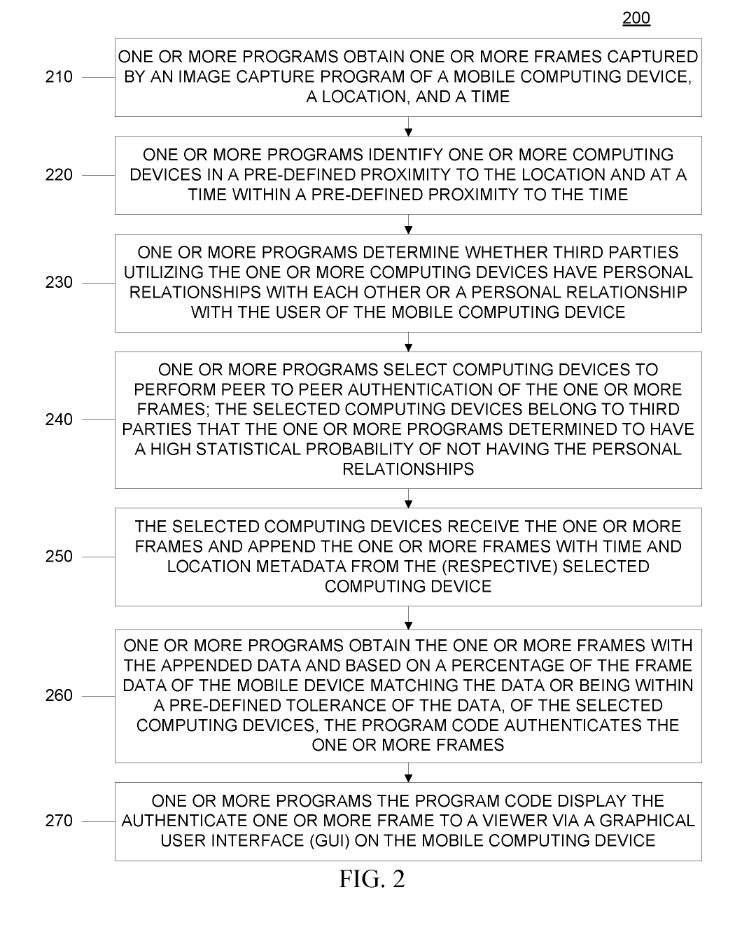

FIG. 2 is a workflow 200 of an embodiment of the present invention that illustrates, in particular, aspects related to the peer to peer authentication. This workflow 200 illustrates aspects of the present invention from the perspective of one or more programs that authenticate the one or more frames captures by a computing device. The program code performing the authentication may execute on a processing resource on the computing device of a user who capture a frame and/or may execute on a computing node (e.g., FIG. 3, 10), including a cloud computing node, that communicates with the personal computing device of the user over a network connection, including but not limited to, over an Internet connection.

In an embodiment of the present invention, the program code obtains one or more frames captured by an image capture program of a mobile computing device, data defining a location, indicating a position of the mobile computing device when the mobile computing device captured the one or more frames, and a time, indicating when the one or more frames were captured by the mobile computing device (210). In an embodiment of the present invention, the program code obtains this location by communicating with location services (e.g., a GPS navigational system) executing on a processing circuit of the mobile computing device.

In another embodiment of the present invention, the program code obtains the location from Wi-Fi hotspot data the program code obtains from the mobile computing device. The program may also obtain location information from both the location services and the Wi-Fi hotspot and correlate the data to determine an accurate and/or concatenated value for the location. In an embodiment of the present invention, the program code communicates with an access point proximate to the mobile computing device to obtain the service set identifier (SSID) value of the access point and utilizes the SSID value to provide one or more of the location or the date. In an embodiment of the present invention, the program code obtains the time based on a timestamp in metadata associated with the frame. In an embodiment of the present invention, the program code obtains a date stamp, a GPS location, and a SSID value from the location where the frame was captured.

Returning to FIG. 2, the program code identifies one or more computing devices in a pre-defined proximity to the location and at a time within a pre-defined proximity to the time indicating when the frame was captured by the mobile computing device (220). Users of these one or more computing devices include third-parties (e.g., crowd sourced participants) passing by within the proximity of the location. In an embodiment of the present invention, the program code may identify the one or more computing devices based on the mobile computing device publicly broadcasting a request to proximate computing devices to assist. The request is for the proximate computing devices to verify the one or more frames.

In an embodiment of the present invention, the program code accesses the one or more computing devices and executes algorithms to determine, based on personally identifiable information available on the one or more computing devices, whether third parties described in the personally identifiable information have personal relationships with each other or a personal relationship with the user of the mobile computing device (230).

Based on determining that a portion of the third parties have a high statistical probability of not having personal relationships with each other or a personal relationship with the user, the program code selects computing devices from the one or more computing devices to perform peer to peer authentication of the one or more frames; the computing devices are those utilized by the portion of the third parties (240). In an embodiment of the present invention, the program code executes algorithms that access contacts in the mobile computing devices to determine relationships between the individuals. The program code may also utilize algorithms that correlate biographical information, as well as other descriptive parameters, available in the mobile computing devices, to determine probabilities that the individuals are acquainted with each other, based on commonality of the information.

In an embodiment of the present invention, the program code can access additional systems to determine whether individuals are associated with each other. For example, in an embodiment of the present invention, the program code may determine if individuals are friends on Facebook, or other personal and/or professional networking sites. In an embodiment of the present invention, the program code may determine if individuals have exchanges communications, such as emails or text messages.

Returning to FIG. 2, the program code utilizes the selected computing devices to authenticate the one or more frames. In an embodiment of the present invention, the program code transmits (or directs one or more programs on the mobile device) to transmit the frame from the mobile computing device to the selected devices, including the data defining the location, and the time indicating when the frame was captured by the mobile computing device. The selected computing devices receive the frame and append the frame with time and location metadata from the (respective) selected computing device (250). The program code obtains the one or more frames with the appended data and based on a percentage of the frame data of the mobile device matching the data, or being within a pre-defined tolerance of the data, of the selected computing devices, the program code authenticates the one or more frames (260). In an embodiment of the present invention, the one or more programs executing on the selected devices encrypt the frame and the additional data appended to the frame by the selected computing device with a public key.

In an embodiment of the present invention, the program code executes on a remote server/cloud as a third party service. Authenticating the frame may include the program code cryptographically signing the frame. Authenticating the frame may include assigning an authenticity score to the frame based on agreement between the data from the frame and data from the various selected computing devices. Thus, rather than authenticating a user in order to authenticate content generated by the user, the program code authenticates settings of computing devices that it associates with a frame or a group of frames.

In an embodiment of the present invention, the program code transmits the authenticated one or more frames to the mobile device. When the mobile device uploads the authenticated one or more frames to a website, the authentication data is uploaded with the one or more frames, so viewers of the one or more frames can identify the one or more frames as authentic.

Returning to FIG. 2, in an embodiment of the present invention, the program code displays the authenticated one or more frames to a viewer via a graphical user interface (GUI) on the mobile computing device (270). In an embodiment of the present invention, the program code displays the frame with the authenticity score, the score representing a level of authenticity of the image.

Referring now to FIG. 3, a schematic of an example of a computing node, which can be a cloud computing node 10. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In an embodiment of the present invention, the computer system which is imaged during runtime by one or more programs in an embodiment of the present invention can be understood as cloud computing node 10 (FIG. 3) and if not a cloud computing node 10, then one or more general computing node that includes aspects of the cloud computing node 10.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 that can be utilized as cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

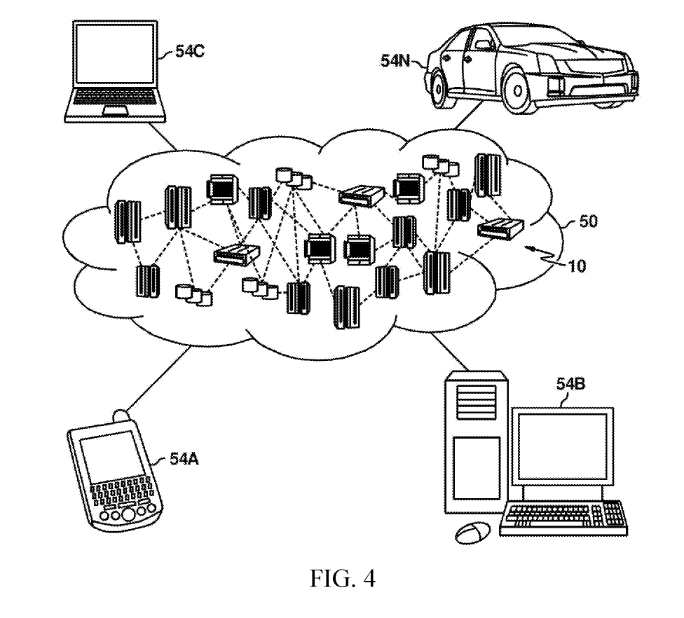

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

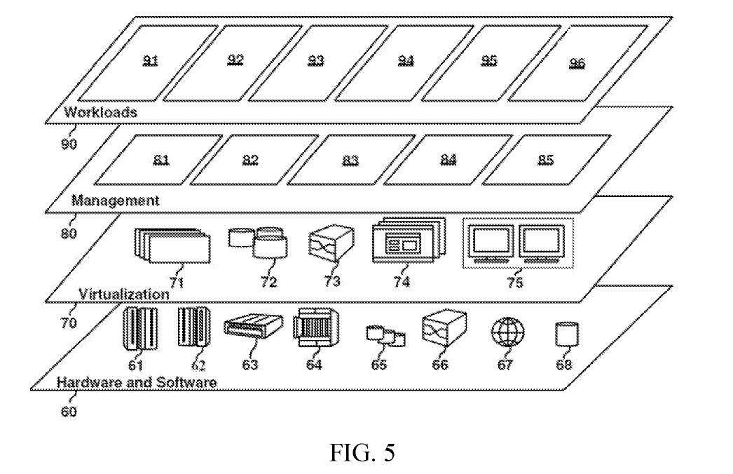

Referring now to FIG. 5, a set of functional abstraction layers provided by cloud computing environment 50 (FIG. 5) is shown. It should be understood in advance that the components, layers, and functions shown in FIG. 5are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and authenticating one or more frames 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method, comprising:
obtaining, by one or more processors, one or more frames captured by an image capture program of a first client, data indicating a location at which the one or more frames were captured, and data indicating a time at which the one or more frames were captured;
identifying, by the one or more processors, a plurality of clients of third parties within a pre-defined proximity of the location and at a time within a pre-defined proximity to the time at which the one or more frames were captured;
determining, by the one or more processors, based on executing algorithms on personally identifiable information on the plurality of clients, probabilities of whether the third parties have personal relationships with each other and probabilities of whether each third party of the third parties has a personal relationship with a user of the first client;
selecting, by the one or more processors, one or more clients from the plurality of clients, wherein a portion of the third parties associated with the one or more clients have a high statistical probability of not having the personal relationships with each other and have a high statistical probability of not having the personal relationship with the user, wherein the selected one or more clients receive the one or more frames and each client of the one or more clients appends the one or more frames with client time and client location metadata;
receiving, by the one or more processors, from each of the one or more clients, the one or more frames appended with the metadata of the client; and
authenticating, by the one or more processors, the one or more frames, based on correlating the data indicating the location at which the one or more frames were captured and the data indicating a time at which the one or more frames were captured with the metadata of the one or more clients.

2. The computer-implemented method of claim 1, further comprising:
displaying, by the one or more processor, in a graphical user interface (GUI) of the client, the authenticated one or more frames.

3. The computer-implemented method of claim 1, wherein the authenticating comprises assigning an authenticity score to the one or more frames reflecting a degree of correlation, the method further comprising:
displaying, by the one or more processor, in a graphical user interface (GUI) of the client, the authenticated one or more frames with the authenticity score.

4. The computer-implemented method of claim 1, wherein the selected one or more clients encrypt the one or more frames and the metadata utilizing a public PKI (public key infrastructure) system key.

5. The computer-implemented method of claim 4, the receiving the one or more frames appended with the metadata of the client further comprising:
decrypting, by the one or more processors, the one or more frames appended with the metadata.

6. The computer-implemented method of claim 1, wherein obtaining data indicating the location at which the one or more frames were captured comprising:
querying, by the one or more processors, location services executing on the client; and
obtaining, by the one or more processors, the data indicating the location, responsive to the querying.

7. The computer-implemented method of claim 6, wherein the location services comprise a global positioning system (GPS).

8. The computer-implemented method of claim 1, wherein obtaining data indicating a time at which the one or more frames were captured comprises obtaining a short for service set identifier (SSID) date from an access point proximate to the client and accessed by the client over a wireless network.

9. The computer-implemented method of claim 1, wherein the identifying the plurality of clients comprises:
monitoring, by the one or more processors, a public broadcast by the client comprising a request for third party authentication of the one or more frames; and
identifying, by the one or more processors, the plurality of clients, based on the plurality of clients responding to the public broadcast.

10. The computer-implemented method of claim 9, wherein the public broadcast further comprises the one or more frames.

11. A computer program product comprising:
a computer readable storage medium readable by one or more processors and storing instructions for execution by the one or more processors for performing a method comprising:
obtaining, by one or more processors, one or more frames captured by an image capture program of a first client, data indicating a location at which the one or more frames were captured, and data indicating a time at which the one or more frames were captured;
identifying, by the one or more processors, a plurality of clients of third parties within a pre-defined proximity of the location and at a time within a pre-defined proximity to the time at which the one or more frames were captured;
determining, by the one or more processors, based on executing algorithms on personally identifiable information on the plurality of clients, probabilities of whether the third parties have personal relationships with each other and probabilities of whether each third party of the third parties has a personal relationship with a user of the first client;
selecting, by the one or more processors, one or more clients from the plurality of clients, wherein a portion of the third parties associated with the one or more clients have a high statistical probability of not having the personal relationships with each other and have a high statistical probability of not having the personal relationship with the user, wherein the selected one or more clients receive the one or more frames and each client of the one or more clients appends the one or more frames with client time and client location metadata;
receiving, by the one or more processors, from each of the one or more clients, the one or more frames appended with the metadata of the client; and
authenticating, by the one or more processors, the one or more frames, based on correlating the data indicating the location at which the one or more frames were captured and the data indicating a time at which the one or more frames were captured with the metadata of the one or more clients.

12. The computer program product of claim 11, the method further comprising:
displaying, by the one or more processor, in a graphical user interface (GUI) of the client, the authenticated one or more frames.

13. The computer program product of claim 11, wherein the authenticating comprises assigning an authenticity score to the one or more frames reflecting a degree of correlation, the method further comprising:
displaying, by the one or more processor, in a graphical user interface (GUI) of the client, the authenticated one or more frames with the authenticity score.

14. The computer program product of claim 11, wherein the selected one or more clients encrypt the one or more frames and the metadata utilizing a public PKI (public key infrastructure) system key.

15. The computer program product of claim 14, the receiving the one or more frames appended with the metadata of the client further comprising:
decrypting, by the one or more processors, the one or more frames appended with the metadata.

16. The computer program product of claim 11, wherein obtaining data indicating the location at which the one or more frames were captured comprising:
querying, by the one or more processors, location services executing on the client; and
obtaining, by the one or more processors, the data indicating the location, responsive to the querying.

17. The computer program product of claim 16, wherein the location services comprise a global positioning system (GPS).

18. The computer program product of claim 11, wherein obtaining data indicating a time at which the one or more frames were captured comprises obtaining a short for service set identifier (SSID) date from an access point proximate to the client and accessed by the client over a wireless network.

19. The computer program product of claim 11, wherein the identifying the plurality of clients comprises:
monitoring, by the one or more processors, a public broadcast by the client comprising a request for third party authentication of the one or more frames; and
identifying, by the one or more processors, the plurality of clients, based on the plurality of clients responding to the public broadcast.

20. A system comprising:
a memory;
one or more processors in communication with the memory; and
program instructions executable by the one or more processors via the memory to perform a method, the method comprising:
obtaining, by one or more processors, one or more frames captured by an image capture program of a first client, data indicating a location at which the one or more frames were captured, and data indicating a time at which the one or more frames were captured;
identifying, by the one or more processors, a plurality of clients of third parties within a pre-defined proximity of the location and at a time within a pre-defined proximity to the time at which the one or more frames were captured;
determining, by the one or more processors, based on executing algorithms on personally identifiable information on the plurality of clients, probabilities of whether the third parties have personal relationships with each other and probabilities of whether each third party of the third parties has a personal relationship with a user of the first client;
selecting, by the one or more processors, one or more clients from the plurality of clients, wherein a portion of the third parties associated with the one or more clients have a high statistical probability of not having the personal relationships with each other and have a high statistical probability of not having the personal relationship with the user, wherein the selected one or more clients receive the one or more frames and each client of the one or more clients appends the one or more frames with client time and client location metadata;
receiving, by the one or more processors, from each of the one or more clients, the one or more frames appended with the metadata of the client; and
authenticating, by the one or more processors, the one or more frames, based on correlating the data indicating the location at which the one or more frames were captured and the data indicating a time at which the one or more frames were captured with the metadata of the one or more clients.
